(19) United States
(12) Patent Application Publication
(10) Pub. No.: US 2005/0038786 A1
(43) Pub. Date: Feb. 17, 2005

(54) Self-configuration of database tables

(75) Inventor: Richard Yonts, Tucson, AZ (US)

Correspondence Address: SWANSON & BRATSCHUN, LLC - IBM, 1745 SHEA CENTER DRIVE, SUITE 330, HIGHLANDS RANCH, CO, 80129, US

(73) Assignee: International Business Machines Corporation (IBM), Armonk, NY (US)

(21) Appl. No.: 10/638,911

(22) Filed: Aug. 11, 2003

(51) Int. Cl. G06F 17/30

(52) U.S. Cl. 707/9

(57) ABSTRACT

A system is provided for accessing data in a database by automatically configuring database tables from within an application program. The system comprises a database, an application program and a table definition module. The database comprises one or more tables, each having one or more data columns. The application program comprises means for requesting access to a database table and means for executing an attempt to access the database table. The table definition module comprises means for intercepting an error message if the attempt to access the database table fails and means for attempting to correct a database table defect in response to the error message. The application program further comprises means for re-executing the attempt to access the database table following correction of the database table defect. Defects corrected by the table definition module may include an absent column, an absent table, and an undefined table.

### FIELD OF INVENTION

The present invention relates generally to computer database systems and, in particular, to self-configuration of database tables.

### COPYRIGHTED MATERIAL

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

Data stored in a database is typically stored in tables comprised of columns and rows (records). The attributes and configuration of each table are established by table definitions which may include such parameters as: table name, column names, data types for each column, length of column entries, decimal formatting of numerical column entries, default values, etc. An application program accesses the data through a database management system, thereby being able to read, write, modify, move and delete selected records or fields within records. Such operations, and other related data operations, will be collectively referred to herein as “access”. FIG. 1 illustrates a block diagram of a prior art system 100 on which a database application 102 is executed and accesses a database 104. The application 102 and database 104 are stored in a memory 106 of the system 100. The memory 106 also stores an operating system 108 and various drivers 110. Coupled to the memory 106, a processor 112 executes code instructions and various peripherals 114 may provide external storage and input/output.

Database systems are typically not self-configuring. Applications must be written against the physical database description (i.e., the tables and table attributes). When an application is first run, an initial configuration is required to be performed to create application specific database tables, an operation which may require human intervention (or execution of specialized code). If a database table later changes, applications utilizing the changed table should receive an appropriate error message (errors reflecting, for example, an absent table, an undefined table or an absent column) and modifications made to reflect the changes, again often requiring human intervention. For tables and table attributes that are widely used throughout a system, updating applications using particular database descriptions may entail a tremendous amount of work in identifying and then properly updating the affected applications.

Database performance may be enhanced by changing the physical structure of the database, and therefore the description as well, to more clearly fit the manner in which the database is being utilized. For example, if a table is being heavily utilized by many applications and very few of the applications need to write to a particular column then performance may be enhanced by splitting the table into two tables, which requires updating both table definitions and the accessing applications.

Updating an application and repairing database tables is a time consuming and error prone process, whether to correct errors or for tuning. An analysis must be made of what needs to be modified (based on, for example, error messages), a decision must be made as to how best to change it, the changes must be made and then testing performed to ensure that the modifications actually provide the expected functionality without any unexpected side effects. Such modifications also require the use of computer resources which increases the cost of updating the application. Only after testing and debugging can applications be brought back on-line with the updated database tables.

Thus, a need exists for improved configuration and re-configuration of database tables in the event of errors reflecting, for example, an absent table, an undefined table or an absent column.

### SUMMARY OF THE INVENTION

The present invention provides systems, methods and program storage devices for accessing data in a database by automatically configuring database tables from within an application program. A system for accessing data according to the present invention comprises a database, an application program and a table definition module. The database comprises one or more tables, each having one or more data columns. The application program comprises means for requesting access to a database table and means for executing an attempt to access the database table. The table definition module comprises means for intercepting an error message if the attempt to access the database table fails and means for attempting to correct a database table defect in response to the error message. The application program further comprises means for re-executing the attempt to access the database table following correction of the database table defect.

A method for accessing data in a database comprises opening an application program, receiving a request to access a database table, attempting a first execution of instructions in the application program to access the database table, intercepting in a table definition module an error message if the database table is defective, executing instructions within the table definition module to correct the database table defect in response to the error message, and following correction of the database table defect, attempting a second execution of the instructions to access the database table.

A program storage device of the present invention embodies a computer-executable program comprising instructions for opening an application program, receiving a request to access a database table, attempting a first execution of instructions in the application program to access the database table, intercepting in a table definition module an error message if the database table is defective, executing instructions within the table definition module to correct the database table defect in response to the error message, and following correction of the database table defect, attempting a second execution of the instructions to access the database table.

In one embodiment, the table definition module is part of the application program. In another embodiment, the table definition module is utilized by several applications, each of which accesses the database. Defects corrected by the table definition module may include an absent column, an absent table, and an undefined table.

### BRIEF DESCRIPTION OF THE DRAWINGS

FIG. 1 illustrates a block diagram of a prior art database system;

FIG. 2 illustrates the structure of an exemplary table from a database;

FIG. 3 illustrates a block diagram of a database system of the present invention; and

FIG. 4 is a flow chart of a method of the present invention.

### DETAILED DESCRIPTION OF THE INVENTION

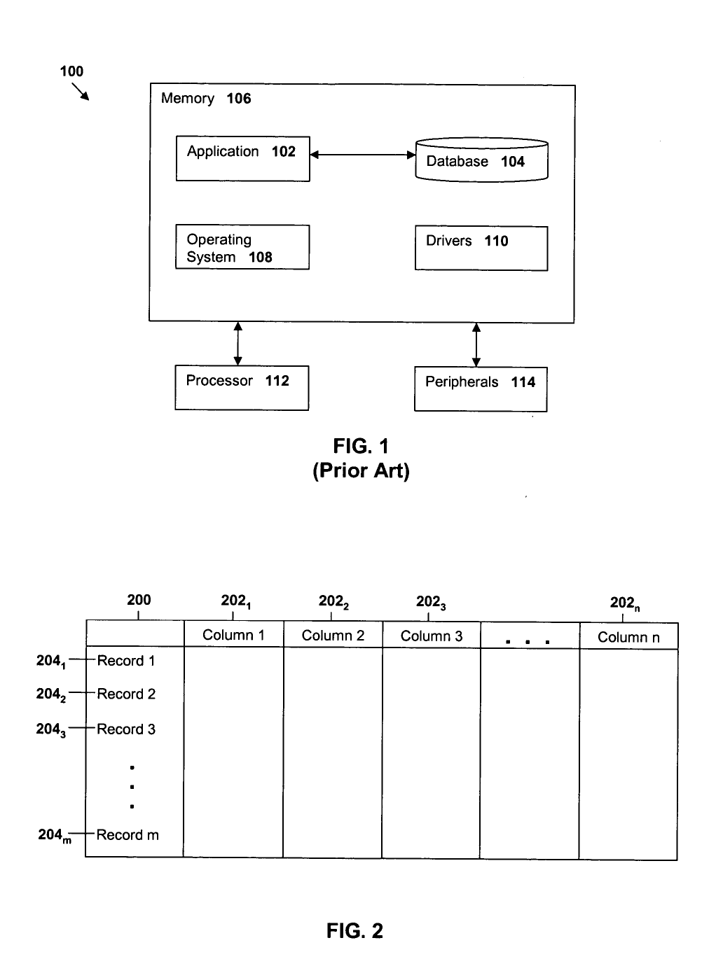

FIG. 2 illustrates the structure of an exemplary database table 200 comprising one or more columns 202₁-202ₙ. Data is entered as records in rows 204₁-204ₘ.

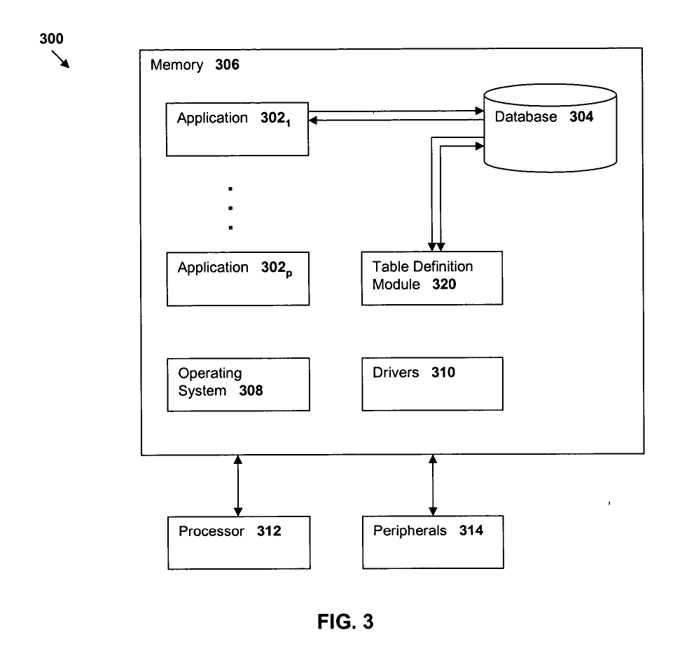

FIG. 3 illustrates a block diagram of a database system 300 of the present invention. One or more application programs 302₁-302ₚ and a database 304 are stored in a memory 306 along with an operating system 308 and drivers 310. A processor 312 and peripherals 314 are coupled to the memory 306. It will be appreciated that showing the memory 306 as a single unit is merely illustrative and the contents of the memory 306 may reside in other locations.

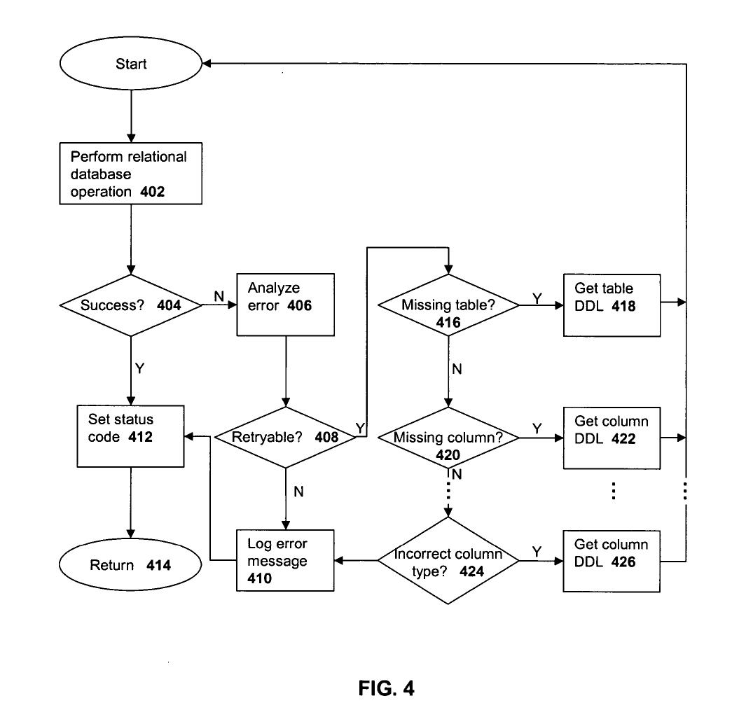

Additionally, the memory 306 comprises a table definition module 320. The table definition module 320 comprises database table definitions and may be part of the instructions comprising one or more applications 302₁-302ₚ or it may be separate and able to be called by any application 302₁-302ₚ which accesses the database 304. Referring to the flow chart of FIG. 4, when an application requires access to a table in the database 304 (step 402), an exception or error message will be generated (step 404) if, for example, the table is being accessed for the first time. The error is intercepted by the table definition module 320 which evaluates the error message (step 406). Another attempt is made (step 408); if unsuccessful, an appropriate error message is logged (step 410), a status code set (step 412) and the instructions return control back to the application (step 414). If the error is the result of a missing table (step 416), instructions within the table definition module 320 (containing the data definition language or DDL) are executed to create the absent table (step 418). Similarly, if the error is the result of a missing column in a table (step 420), instructions within the table definition module 320 are executed to create the absent column (step 422). And, if the error is the result of an undefined table, incorrect table type or other such defect (step 424), instructions within the table definition module 320 are executed to correct the defect (step 426). After the table has been created, defined or corrected, access is again attempted. If all of the recoverable errors have been addressed, the application will resume normal operation (step 414).

Consequently, the need for human intervention is significantly reduced in that tables may be configured and typical table defects may corrected automatically from within an application (or from a call from an application). In one embodiment, table definition module 320 includes definitions of database tables and utilizes the definitions, for example, when constructing an/or modifying one or more tables.

The Appendix contains exemplary code instructions for a table definition module according to the present invention, written in Java for a SQL compliant database.

The present invention may be embodied as a system, a method or a computer program product for accessing a database. As will be appreciated by those of skill in the art, the present invention may take the form of an entirely hardware embodiment, an entirely software embodiment (including firmware, resident software, micro-code, etc.) or an embodiment containing both hardware and software aspects. Furthermore, the present invention may take the form of a computer program product on a computer-usable or computer-readable program code means embodied in the medium for use by or in connection with an instruction execution system and used to program a computer to perform any of the processes of the present invention. In the context of this document, a computer-usable or computer-readable medium may be any means which can contain, store, communicate, propagate or transport the program for use by or in connection with the instruction execution system, apparatus or device.

The computer-usable or computer-readable medium may be, for example, but not limited to, an electronic, magnetic, optical, electromagnetic, infrared or semiconductor system, device or propagation medium. More specific examples (though a non-exhaustive list) of the computer-usable or computer-readable medium may include: floppy disks, optical discs, DVD, CD-ROMs, and magneto-optical disks, ROM, RAM, EPROMs, EEPROMS, magnetic or optical cards, or any type of media suitable for storing electronic instructions. Note that the computer-usable or computer-readable medium may even be paper or other suitable medium upon which the program is printed, as the program may be electronically captured via, for example, optical scanning of the paper or other medium, then compiled, interpreted or otherwise processed in a suitable manner if necessary, and stored in a computer memory.

The objects of the invention have been fully realized through the embodiments disclosed herein. It will be appreciated that the specific errors discussed herein are merely representative of errors to which the present invention is applicable. The list is not meant to be exhaustive and the present invention is applicable to other recoverable errors as well. Those skilled in the art will also appreciate that the various aspects of the invention may be achieved through different embodiments without departing from the essential function of the invention.

1. A method of accessing data in a database, comprising:
receiving a request to access a database table;
attempting a first execution of instructions in an application program to access the database table;
intercepting in a table definition module an error message if the database table is defective;
in response to the error message, executing instructions within the table definition module to correct a database table defect; and
following correction of the database table defect, attempting a second execution of the instructions to access the database table.

2. The method of claim 1, wherein if the error message indicates that a column in the database table is absent, executing instructions within the table definition module to create the column.

3. The method of claim 1, wherein if the error message indicates that the database table is absent, executing instructions within the table definition module to create the database table.

4. The method of claim 1, wherein if the error message indicates that the database table is undefined, executing instructions within the table definition module to define the database table.

5. The method of claim 1, wherein the database table defect is one of an absent table, an undefined table and an absent column within a table.

6. The method of claim 1, wherein the application program includes the table definition module.

7. A system for accessing data, comprising:
a database comprising one or more tables, each comprising one or more columns for storing data;
an application program, comprising:
means for requesting access to a database table; and
means for executing an attempt to access the database table; and
a table definition module, comprising:
means for intercepting an error message if the attempt to access the database table fails; and
means for attempting to correct a database table defect in response to the error message;
the application program further comprising means for re-executing the attempt to access the database table following correction of the database table.

8. The system of claim 7, wherein the application program further comprises the table definition module.

9. The system of claim 7, wherein the application program further comprises means for calling the table definition module.

10. The system of claim 7, wherein the means for attempting to correct the database table defect comprises:
means for creating a column if the error message indicates that the column in the database table is absent;
means for creating the database table if the error message indicates that the database table is absent; and
means for defining the database table if the error message indicates that the database table is undefined.

11. The system of claim 7, further comprising an additional application program, wherein:
the additional application program comprises:
means for requesting access to the database table; and
means for executing an attempt to access the database table; and
the application program and the additional application program each further comprise means for calling the table definition module.

12. The system of claim 11, wherein the means for attempting to correct the database table defect comprises:
means for creating a column if the error message indicates that the column in the database table is absent;
means for creating the database table if the error message indicates that the database table is absent; and
means for defining the database table if the error message indicates that the database table is undefined.

13. A program storage device readable by a computer coupled to a database and an application program, the program storage device tangibly embodying a program executable by the computer and comprising instructions for:
opening an application program;
receiving a request to access a database table;
attempting a first execution of instructions in the application program to access the database table;
intercepting in a table definition module an error message if the database table is defective;
in response to the error message, executing instructions within the table definition module to correct a database table defect; and
following correction of the database table defect, attempting a second execution of the instructions to access the database table.

14. The program storage device of claim 13, wherein the instructions to correct the database table defect comprise instructions within the table definition module to create a column if the error message indicates that the column in the database table is absent.

15. The program storage device of claim 14, wherein the instructions to correct the database table defect comprise instructions within the table definition module to create the database table if the error message indicates that the database table is absent.

16. The program storage device of claim 13, wherein the instructions to correct the database table defect comprise instructions within the table definition module to define the database table if the error message indicates that the database table is undefined.

17. The program storage device of claim 13, wherein the instructions to correct the database table defect comprise instructions within the table definition module to:
create a column if the error message indicates that the column in the database table is absent;
create the database table if the error message indicates that the database table is absent; and
define the database table if the error message indicates that the database table is undefined.

18. The program storage device of claim 13, wherein instructions in the application program comprise the table definition module.
